(19) United States
(12) Patent Application Publication
(10) Pub. No.: US 2005/0254511 A1
(43) Pub. Date: Nov. 17, 2005

(54) Frame transmission interval

(75) Inventor: Sami J. Kekki, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/992,011

(22) Filed: Nov. 19, 2004

(30) Foreign Application Priority Data
May 11, 2004 (GB) 0410481.6

(51) Int. Cl. H04L 12/26

(52) U.S. Cl. 370/437

(57) ABSTRACT

There is disclosed a method of determining a frame transmission interval for a channel between a network access point and a network access controller, the method comprising the steps of: determining a frame transmission interval value at the network access controller; transmitting the determined frame transmission interval value from the network access controller to the network access point; receiving the frame transmission interval value at the network access point.

### BACKGROUND TO THE INVENTION

1. Field of the Invention

The invention relates to transmission rates in the access network of a communication system.

2. Description of the Related Art

A mobile communication system is an example of a system in which an access network is provided to allow access to the system functionality for user terminals.

In a universal mobile telecommunications system (UMTS), a radio access network typically provides access for user equipment to a mobile communications system core network. The user equipment typically communicates with the access network over a radio interface, the access network including a plurality of Node Bs, or more generally network access points, with which the user equipment establishes a connection.

Each of the Node Bs is connected to a radio network controller, or more generally a network access controller.

A dedicated channel (DCH) is provided for uplink traffic from the user equipment to the radio network controller via the Node B. A frame transmission interval is defined for this channel. The frame transmission interval is 10 ms.

In 3GPP TSG-RAN there has been proposed an enhanced DCH, E-DCH. In proposing the E-DCH, it has been discussed to provide a shorter frame transmission interval of 2 ms.

A problem may arise in that the shorter frame transmission interval may not be supported by all radio access network elements, and thus the introduction of E-DCH may not be widely compatible with existing systems and technologies.

### SUMMARY OF THE INVENTION

It is an aim of the invention to provide an improvement to the control or configuration of the enhanced DCH uplink transport channel.

In accordance with one aspect of the present invention there is provided a method of determining a frame transmission interval for a channel between a network access controller and a network access point, the method comprising the steps, at the network access point, of: storing at least one default frame transmission interval value for the channel; receiving a frame transmission interval value for the channel; selectively applying either the received frame transmission interval value or the at least one default frame transmission interval value. The channel is preferably an enhanced dedicated channel (E-DCH) transport channel.

The method is preferably implemented in a mobile communications system, preferably a UMTS system. The network access point is preferably a Node B and the network access controller is a radio network controller.

The step of receiving the frame transmission interval value may comprise receiving said value from the network access controller.

The step of receiving the frame transmission interval value may comprise receiving said value in a NBAP/RNSAP protocol message. The step of receiving the frame transmission interval value may comprise receiving said value in an Information IE Group of an NBAP message. The frame transmission interval value may be a parameter of the Enhanced Dedicated Channel Information IE Group of the NBAP message.

Responsive to the step of applying the at least one frame transmission interval default value, the method may further comprise the step of transmitting the applied default value. The step of transmitting the applied default value may comprise transmitting said value to the network access controller.

The step of transmitting the default value may comprise transmitting the default value as a parameter in a NBAP response message. The step of transmitting the default value may comprise transmitting the default value as a parameter in an enhanced DCH specific part of the NBAP reply message.

In a further aspect the invention provides a method of determining a frame transmission interval for a channel between a network access controller and a network access point, the method comprising the steps, at the network access controller, of: determining a frame transmission interval value; and transmitting the determined frame transmission interval to a network access point. The channel is preferably a transport channel, preferably an enhanced DCH transport channel.

The step of determining a frame transmission interval value may comprise the step of selecting said value from a plurality of frame transmission interval values. The plurality of frame transmission values may comprise a plurality of predetermined values.

The step of determining the frame transmission interval value may be independent of any value in an interface between the network access point and a user equipment.

The step of determining the frame transmission interval value may be dependent upon characteristics of a communication session to be established.

The step of determining the frame transmission interval value may be dependent upon the availability of processing resources and/or capabilities in the network access controller.

The step of transmitting the determined frame transmission interval to a network access point may comprise transmitting said value in a NBAP/RNSAP protocol message. The step of transmitting the determined frame transmission interval to a network access point may comprise transmitting said value in an Information IE Group of an NBAP message or in an equivalent IE or IE Group of an NBAP message. The frame transmission interval value may be a parameter of the Information IE Group of the NBAP message or a parameter in an equivalent IE or IE Group of an NBAP message.

The method may further comprise the step, after said transmitting step, of receiving a notification of a default frame transmission interval value from the network access point, wherein said default value overrides said determined value.

The step of receiving the default value may comprise receiving a parameter in a NBAP reply message. The default value may be received as a parameter in an enhanced DCH specific part of the NBAP reply message.

In another aspect, the invention provides a method of determining a frame transmission interval for a channel between a network access point and a network access controller, the method comprising the steps of: determining a frame transmission interval value at the network access controller; transmitting the determined frame transmission interval value from the network access controller to the network access point; receiving the frame transmission interval value at the network access point. The channel is preferably a transport channel.

The step of determining a frame transmission interval value may comprise the step of selecting said value from a plurality of frame transmission interval values.

The method may further comprise the step of storing at least one default frame transmission interval value for the channel at the network access point; and selectively applying one of either the received frame transmission interval value or the at least one default frame transmission interval value.

The channel is preferably an enhanced DCH transport channel.

In a further aspect there is provided by the invention a setup message for establishing a channel or a reconfiguration message for reconfiguring a channel between a network access point and a network access controller, the setup message including a field identifying a frame transmission interval selected by the network access controller for the channel.

The setup message preferably comprises a NBAP/RNSAP protocol message, the field identifying a frame transmission interval selected by the network access controller for the channel being included in an information element.

In a further aspect there is provided by the invention a response message for establishing a channel between a network access point and a network access controller, the response message including a field identifying a frame transmission interval selected by the network access controller for the channel.

The response message may comprise a NBAP/RNSAP protocol message, the field identifying a frame transmission interval selected by the network access controller for the channel being included in an enhanced dedicated physical channel specific part of the message.

The channel is preferably an enhanced dedicated physical transport channel.

In another aspect the invention provides a network access point adapted to determine a frame transmission interval for a channel between a network access controller and the network access point, the network access point comprising: storage means for storing at least one default frame transmission interval value for the channel; receiving means for receiving a frame transmission interval value for the channel; and selection means for selectively applying either the received frame transmission interval value or the at least one default frame transmission interval value.

The network access point preferably comprises a Node B of a mobile communication system, the network access controller being a radio network controller.

The receiving means may be adapted to receive said value from the network access controller.

The network access point may further comprise transmitting means, responsive to the selection means applying the at least one frame transmission interval default value, for transmitting the applied default value.

The invention may yet further provide a network access controller adapted to determine a frame transmission interval for a channel between the network access controller and a network access point, the network access controller comprising: determining means for determining a frame transmission interval value; and transmitting means for transmitting the determined frame transmission interval to the network access point.

The determining means may include selection means for selecting said value from a plurality of frame transmission interval values.

The plurality of frame transmission values may comprise a plurality of predetermined values.

The determining means may operate independently of any value in an interface between the network access point and a user equipment.

The determining means may be adapted to be dependent upon characteristics of a communication session to be established.

The network access controller may further comprise receiving means for receiving a notification of a default frame transmission interval value from the network access point, wherein said default value overrides said determined value.

The invention, in an arrangement, provides a mobile communication system including a network access point and a network access controller, said system being adapted to determine a frame transmission interval for a channel between the network access controller and the network access point, the network access controller comprising: determining means for determining a frame transmission interval value; and transmitting means for transmitting the determined frame transmission interval to the network access point; and the network access point comprising: storage means for storing at least one default frame transmission interval value for the channel; receiving means for receiving a frame transmission interval value for the channel; and selection means for selectively applying either the received frame transmission interval value or the at least one default frame transmission interval value.

The determining means may be adapted to select said value from a plurality of frame transmission interval values.

The channel is preferably an enhanced DCH transport.

It should be noted that, in preferred embodiments where the NBAP protocol is used, the NBAP protocol is used between the network access controller and the network access point. It should also be noted that, in preferred embodiments were the RNSAP protocol is used, the RNSAP protocol is used between network access controllers.

In general, in relation to all embodiments of the invention, if the Iᵤᵣ interface is involved, the frame transmission interval is still preferably selected for the communication between the network access controller and the network access point. The additional network access controller preferably is the controlling network access controller of the network access point, whilst the other RNC is the serving RNC of the user equipment attached t0o the network access point.

### BRIEF DESCRIPTION OF THE FIGURES

The invention will now be described by way of example with reference to the accompanying figures, in which:

FIG. 1 illustrates a section of a UMTS system in which embodiments of the invention may be applied; and

FIG. 2 illustrates a flow process in accordance with a preferred embodiment of the invention.

### DESCRIPTION OF THE PREFERRED EMBODIMENTS

The invention is described herein by way of reference to particular example scenarios. In particular the invention is described in relation to elements of a universal mobile communication telecommunications system (UMTS).

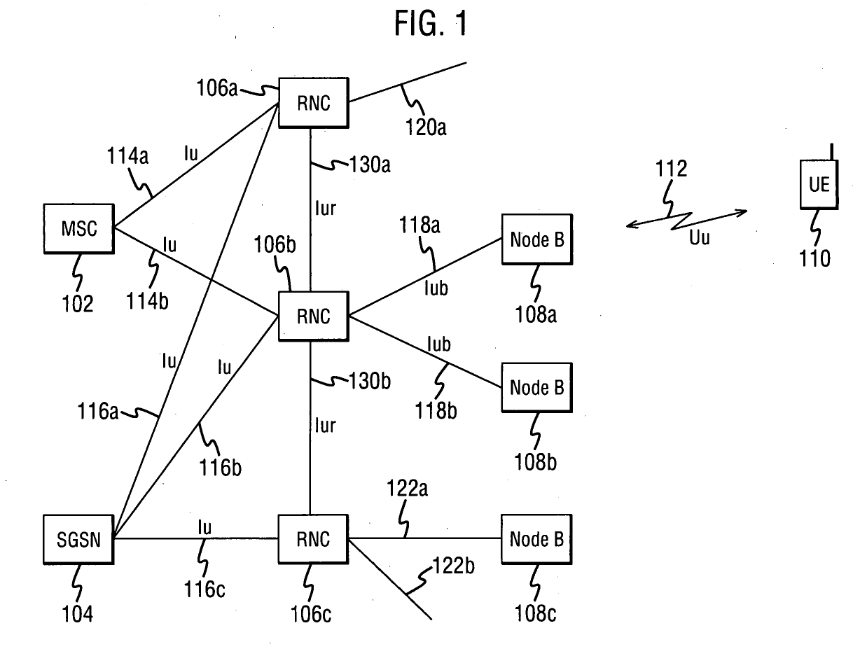

In FIG. 1, there is illustrated those elements of a UMTS system necessary for understanding embodiments of the present invention. The implementation of a UMTS system will be well-known to one skilled in the art. As such the system is not described in detail herein, but only sufficient elements shown and described as is necessary for an understanding of the invention.

Referring to FIG. 1, an example UMTS system typically includes a mobile switching centre (MSC) 102, a serving GPRS support node (SGSN) 104, a plurality of radio network controllers (RNCs) 106a, 106b, 106c, a plurality of Node Bs 108a, 108b, 108c, and a user equipment (UE) 110.

As is known in the art, the user equipment 110 connects with one of the Node Bs, for example Node B 108a, over a radio interface or air interface 112, known in the art as a Uᵤ interface.

Each Node B is connected to an RNC via an I_{ub} interface. The RNC 106b connects to the Node Bs 108a and 108b via I_{ub} interfaces 118a and 118b respectively, and possibly to one or more other Node Bs. The RNC 106c connects to the Node B 108c via I_{ub} interface 122a, and to one or more other Node Bs via one or more other I_{ub} interfaces, such as interface 122b. The RNC 106a connects to one or more Node Bs via one or more I_{ub} interfaces, such as interface 120a.

The Node Bs themselves are interconnected via an Iᵤᵣ interface. In FIG. 1, it is shown that the RNC 106a is connected to the RNC 106b via an Iᵤᵣ interface 130a, and the RNC 106b is connected to the RNC 106c via an Iᵤᵣ interface 130b. The RNCs 106a and 106c may similarly be interconnected via an Iᵤᵣ interface.

Each of the RNCs in the UMTS system is connected to one or more MSCs or SGSNs via an Iᵤ interface. In the example of FIG. 1, the MSC 102 is connected to the RNCs 106a and 106b via respective Iᵤ interfaces 114a and 114b, and the SGSN 104 is connected to the RNCs 106a, 106b and 106c via respective Iᵤ interfaces 114a, 114b and 114c.

It has been proposed, in 3GPP TSG-RAN, for a new enhanced DCH uplink transport channel. The enhanced DCH uplink transport channel is a channel for transporting traffic from a user equipment to a Node B in the air interface or radio interface Uᵤ, and for transporting traffic from a Node B to an RNC, and between RNCs, on the I_{ub} interface or the Iᵤᵣ interface.

The invention, and embodiments thereof, proposes an adaptation to the enhanced DCH uplink transport channel such that traffic may be transported with a variable frame transmission interval on the I_{ub} interface or the Iᵤᵣ interface. As is discussed further hereinafter, preferably the frame transmission interval on the I_{ub} interface or the Iᵤᵣ interface is independent of a transmission time interval on the Uᵤ interface.

In a preferred embodiment, the traffic is transmitted on the I_{ub} interface or the Iᵤᵣ interface with either a fast frame transmission interval value of 2 ms, as proposed for the enhanced DCH, or with a slower frame transmission interval value of 10 ms, as provided for on the current DCH. The principles of the invention, however, may apply to a selection of any frame transmission interval value. There may be provided a plurality of distinct values to select from, or there may be provided a range within which range any value may be chosen.

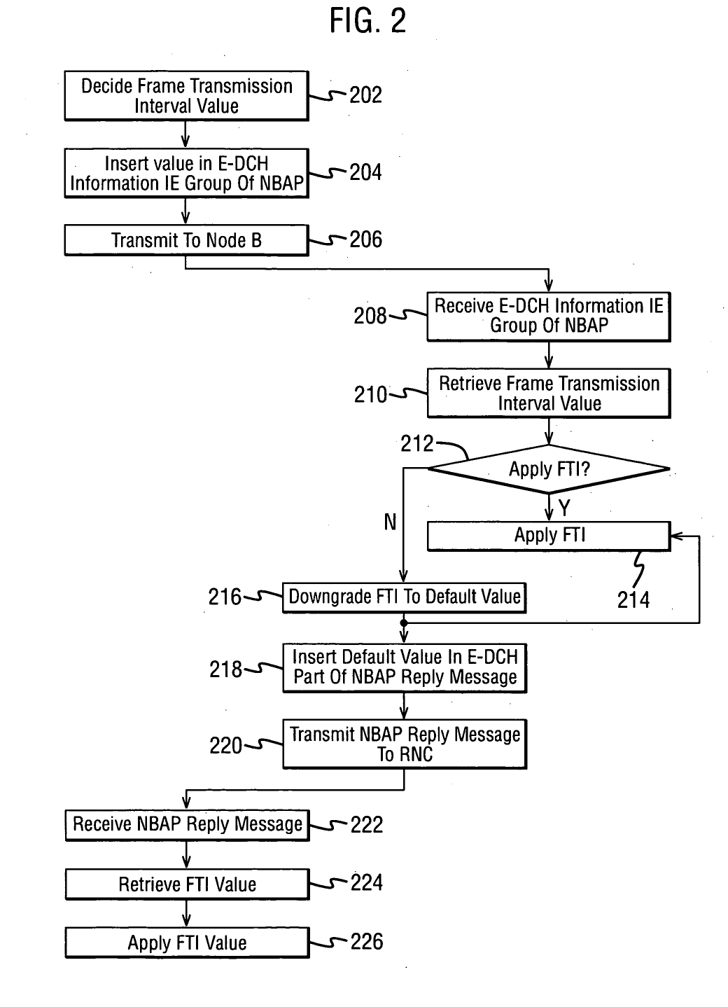

A preferred embodiment of the invention is now described by way of reference to the flow diagram of FIG. 2, and with further reference to FIG. 1.

In a first step 202, a radio network controller, such as the radio network controller 106b, determines a frame transmission interval (FTI) value or transmission time interval (TTI) value, for the enhanced DCH uplink of a particular communication session. The value is chosen from two or more possible values.

The determination of the frame transmission interval by the radio network controller may be achieved in a number of ways. A short frame transmission interval may present a major challenge to a particular radio network controller because of the technical limitations of the element. As such the radio network controller may opt for a longer frame transmission interval. A particular RNC, for example, may not be capable of a short frame transmission interval at all, in which case it will always select a longer frame transmission interval.

Where an RNC is capable of supporting a short frame transmission interval, the radio network controller may also consider the requirements of the corresponding radio bearer for the communication session, and/or the user with which the communication is established, in determining whether to downgrade the value of the frame transmission interval from a short value to a longer value, e.g. from 2 ms to 10 ms.

A large variety of traffic may be transported on the E-DCH. Some traffic may require as short delays as possible, whilst for other traffic it may be possible to tolerate ‘normal’ DCH (rather than enhanced DCH) delays, e.g. 10 ms delays.

Depending on the traffic requirements in the uplink, the radio network controller may choose a shorter or longer frame transmission interval for the I_{ub} interface and the Iᵤᵣ interface. By using only a short interval when required by the traffic, the radio network controller resources can be saved as a shorter interval generally will consume more resources than a corresponding E-DCH with a longer interval, for example due to the larger number of interruptions generated in the short interval.

The determination of the frame transmission interval is based on a selection amongst the available frame transmission intervals. In the preferred embodiment this is a choice between a 2 ms interval and a 10 ms interval. However the invention is not limited to such a choice, and may be a selection between a set of other values, or from within a particular range.

In a step 204 the radio network controller preferably inserts a value corresponding to the determined frame transmission interval in a Node B application part (NBAP) message, for transmission to the appropriate Node B. Preferably a new parameter is defined in the E-DCH Information IE (information element) Group of the NBAP message. This new parameter allows the frame transmission interval value determined by the radio network controller to be represented in the NBAP message. The parameter is preferably termed a “UL FP interval” parameter, corresponding to an “uplink frame parameter interval”. The parameter may be the actual value of the parameter, or a code representing the value. For example where the choice is between the values 2 ms and 10 ms, the parameter may be ‘0’ or ‘1’, denoting respectively each of the possible values. The parameter preferably defines the frame transmission interval over the I_{ub} interface and the Iᵤᵣ interface.

In general, the selected frame transmission interval value is signalled in a message signalled from the radio network controller to the Node B for setting up any given E-DCH.

In a step 206, the message is then transmitted over the I_{ub} interface from the radio network controller, for example RNC 106b, to the node B, for example Node B 108a.

In a step 208, the message is received by the Node B, and the E-DCH information IE group of the NBAP message thus received. As represented by step 210, the frame transmission interval value sent by the radio network controller is then retrieved by the Node B.

Thus, the Node B is notified of the frame transmission interval value determined by the radio network controller, and thus both ends of the communication link have the necessary information to establish communication.

In a step 212, the Node B then may decides whether to apply the received frame transmission interval value to the E-DCH uplink traffic. In one embodiment, the Node B is adapted to automatically use the value received from the radio network controller. In such embodiment, in step 214 the received frame transmission interval is applied. In this embodiment, the applied frame transmission interval value is determined solely by the radio network controller, and thus in dependence on information available to the radio network controller.

In another embodiment, the Node B is adapted to assess the appropriateness of the value provided by the radio network controller. It is expected that the radio network controller will provide the Node B with the best value that it can handle. As such, the Node B is preferably not adapted to upgrade the value of the frame transmission interval received from the radio network controller, so as to avoid setting a value which cannot be supported by the radio network controller. However in alternative arrangements the Node B may upgrade the value set by the radio network controller.

In accordance with a further embodiment, however, the Node B is adapted to determine whether the value of the frame transmission interval should be downgraded from that set by the radio network controller.

The Node B can consider the requirements of the corresponding radio bearer and/or the user in determining whether to downgrade the value. A large variety of traffic may be transported on the E-DCH. Some traffic may require as short delays as possible, whilst for other traffic it may be possible to tolerate ‘normal’ DCH (rather than enhanced DCH) delays.

Preferably the Node B uses information not available to the radio network controller to further enhance the determination of the frame transmission interval value.

If the Node B determines that the value should be downgraded, then in a step 216 a new value is set. Although this new value may be a calculated distinct value, in the preferred embodiment the new value is preferably a fixed default value. In the example where the possible values of the frame transmission interval are 2 ms and 10 ms, if the radio network controller sets a value of 10 ms, then the Node B preferably does not consider changing it. If the radio network controller sets a value of 2 ms, then preferably the Node B considers changing the value, the only possible value to which it can be changed being the alternative, downgraded, value of 10 ms. In an alternative arrangement there may be multiple default values to choose between. At least one default value is preferably stored by the Node B.

On the assumption that the Node B does determine a new value in step 216, the new value is then applied in step 214.

In step 218, the Node B then inserts the selected new value in the E-DCH part of a NBAP reply or response message, to be sent to the radio network controller. As an example, this reply or response message may be a radio link reconfiguration response, in the case of an unsynchronised setup, or a radio link reconfiguration ready response, in the case of a synchronised setup.

The response or reply message will preferably depend upon the E-DCH setup message received from the radio network controller. The response message is preferably a defined response message to a particular setup message.

In general, the radio network controller sends a setup message to the Node B, and the Node B sends an appropriate response message to the radio network controller. Any value necessary to be communicated between the two elements can be inserted in an appropriate field of the appropriate message.

In a step 220 the radio network controller then transmits the appropriate NBAP reply message to the radio network controller.

In a step 222 the radio network controller receives the NBAP reply message, and then in a step 224 retrieves the frame transmission interval value included by the Node B.

In one embodiment the Node B may always include the applied value in the response message, which may be an altered value or the value set by the radio network controller initially. In another embodiment the Node B may only include a value if the value initially set by the radio network controller is changed.

In a step 226, the radio network controller then applies, if necessary, any new value set by the Node B.

In accordance with embodiments of the invention, there is thus preferably provided a technique which allows the optimum frame transmission interval rate to be used in the uplink between the Node B and the radio network controller to be selected or determined from a plurality of possible values, in dependence on requirements identified in both the elements, and independent of a value used in the radio interface.

The selection of the frame transmission interval on the I_{ub} interface and the Iᵤᵣ interface can be independent of the frame transmission interval on the radio interface. Even if the radio interface has a frame transmission interval of 2 ms, the frame transmission interval on the I_{ub} interface and the Iᵤᵣ interface may be longer. In such a case, the E-DCH frame may convey data transmitted in multiple frames in the radio interface. For example, if the radio interface frame transmission interval is 2 ms and the I_{ub} interface frame transmission interval is 10 ms, then the E_DCH frame conveys data of 5*2 ms, if this data is available.

In general, the Node B may be considered to be a network access point, being a point at which a user terminal, such as a user equipment or mobile terminal, accesses a network. In general, the radio network controller may be considered to be a network access controller, being an element which controls network access.

The invention has been described herein by way of reference to particular non-limiting examples. One skilled in the art will understand the general applicability of the invention. The scope of protection afforded by the invention is defined in the appended claims.

1. A method of determining a frame transmission interval for a channel between a network access controller and a network access point, the method comprising the steps of:
storing, at the network access point, at least one default frame transmission interval value for the channel;
receiving a frame transmission interval value for the channel;
selectively applying either the received frame transmission interval value or the at least one default frame transmission interval value.

2. The method according to claim 1, wherein the channel is an enhanced dedicated channel, E-DCH, transport channel.

3. The method according to claim 1, wherein the network access point is a Node B and the network access controller is a radio network controller.

4. The method according to claim 1, wherein the step of receiving the frame transmission interval value comprises receiving said frame transmission interval value from the network access controller.

5. The method according to claim 1, wherein the step of receiving the frame transmission interval value comprises receiving said frame transmission interval value in a NBAP/RNSAP protocol message.

6. The method according to claim 5, wherein the step of receiving the frame transmission interval value comprises receiving said frame transmission interval value in an Information IE Group of an NBAP message.

7. The method according to claim 6, wherein the frame transmission interval value is a parameter of the E-DCH Information IE Group of the NBAP message.

8. The method according to claim 1, wherein responsive to the step of applying the at least one default frame transmission interval value, the method further comprises the step of transmitting an applied default value.

9. The method according to claim 8, wherein the step of transmitting the applied default value comprises transmitting said applied default value to the network access controller.

10. The method according to claim 8, wherein the step of transmitting the applied default value comprises transmitting the applied default value as a parameter in a NBAP response message.

11. The method according to claim 10, wherein the step of transmitting the applied default value comprises transmitting the applied default value as a parameter in an enhanced DCH specific part of the NBAP response message.

12. The method of determining a frame transmission interval for a channel between a network access controller and a network access point, the method comprising the steps of:
determining, at the network access controller, a frame transmission interval value; and
transmitting the determined frame transmission interval value to a network access point.

13. The method according to claim 12, wherein the channel is an enhanced DCH transport channel.

14. The method according to claim 12, wherein the step of determining a frame transmission interval value comprises the step of selecting said frame transmission interval value from a plurality of frame transmission interval values.

15. The method according to claim 14, wherein the plurality of frame transmission interval values comprise a plurality of predetermined values.

16. The method according to claim 12, wherein the step of determining the frame transmission interval value is independent of any value in an interface between the network access point and a user equipment.

17. The method according to claim 12, wherein the step of determining the frame transmission interval value is dependent upon characteristics of a communication session to be established.

18. The method according to claim 12, wherein the step of transmitting the determined frame transmission interval to a network access point comprises transmitting said determined frame transmission interval value in a NBAP/RNSAP protocol message.

19. The method according to claim 12, wherein the step of transmitting the determined frame transmission interval value to a network access point comprises transmitting said determined frame transmission interval value in an Information IE Group of an NBAP message or in an equivalent IE or IE Group of an NBAP message.

20. The method according to claim 19, wherein the determined frame transmission interval value is a parameter of the Information IE Group of the NBAP message or a parameter in an equivalent IE or IE Group of an NBAP message.

21. The method according to claim 12, further comprising the step of receiving a notification of a default frame transmission interval value from the network access point, wherein said default frame transmission interval value overrides said determined frame transmission interval value.

22. The method according to claim 21, wherein step of receiving the default frame transmission interval value comprises receiving a parameter in a NBAP reply message.

23. The method according to claim 22, wherein the default frame transmission interval value is received as a parameter in an enhanced DCH specific part of the NBAP reply message.

24. A method of determining a frame transmission interval for a channel between a network access point and a network access controller, the method comprising the steps of:
determining a frame transmission interval value at the network access controller;
transmitting the determined frame transmission interval value from the network access controller to the network access point;
receiving the frame transmission interval value at the network access point.

25. The method according to claim 24, wherein the step of determining a frame transmission interval value comprises the step of selecting said frame transmission interval value from a plurality of frame transmission interval values.

26. The method according to claim 24, further comprising the step of storing at least one default frame transmission interval value for the channel at the network access point; and selectively applying one of either the received frame transmission interval value or the at least one default frame transmission interval value.

27. The method according to claim 24, wherein the channel is an enhanced DCH transport channel.

28. A setup message for establishing a channel or reconfiguration message for reconfiguring a channel between a network access point and a network access controller, the setup message including a field identifying a frame transmission interval selected by the network access controller for the channel.

29. The setup message according to claim 28, further comprising a NBAP/RNSAP protocol message, the field identifying a frame transmission interval selected by the network access controller for the channel being included in an information element.

30. A response message for establishing a channel between a network access point and a network access controller, the response message including a field identifying a frame transmission interval selected by the network access controller for the channel.

31. The response message according to claim 30, further comprising a NBAP/RNSAP protocol message, the field identifying a frame transmission interval selected by the network access controller for the channel being included in an enhanced dedicated physical channel specific part of the message.

32. The setup message as defined in claim 28, wherein the channel is an enhanced dedicated physical transport channel.

33. The response message as defined in claim 30, wherein the channel is an enhanced dedicated physical transport channel.

34. A network access point configured to determine a frame transmission interval for a channel between a network access controller and the network access point, the network access point comprising:
storage means for storing at least one default frame transmission interval value for the channel;
receiving means for receiving a frame transmission interval value for the channel; and
selection means for selectively applying either the received frame transmission interval value or the at least one default frame transmission interval value.

35. The network access point according to claim 34, further comprising a Node B of a mobile communication system, the network access controller being a radio network controller.

36. The network access point according to claims 34, wherein said receiving means is configured to receive said frame transmission interval value from the network access controller.

37. The network access point according to claim 34, further comprising transmitting means, responsive to the selection means applying the at least one default frame transmission interval value, for transmitting an applied default value.

38. A network access controller configured to determine a frame transmission interval for a channel between the network access controller and a network access point, the network access controller comprising:
determining means for determining a frame transmission interval value; and
transmitting means for transmitting a determined frame transmission interval value to the network access point.

39. The network access controller according to claim 38, wherein the determining means includes selection means for selecting said frame transmission interval value from a plurality of frame transmission interval values.

40. The network access controller according to claim 39, wherein the plurality of frame transmission interval values comprise a plurality of predetermined values.

41. The network access controller according to claim 38, wherein the determining means operates independently of any value in an interface between the network access point and a user equipment.

42. The network access controller according to claim 38, wherein the determining means is configured to be dependent upon characteristics of a communication session to be established.

43. The network access controller according to claim 38, further comprising receiving means for receiving a notification of a default frame transmission interval value from the network access point, wherein said default frame transmission interval value overrides said determined frame transmission interval value.

44. A mobile communication system including a network access point and a network access controller, said system being configured to determine a frame transmission interval for a channel between the network access controller and the network access point, the network access controller comprising:
determining means for determining a frame transmission interval value; and
transmitting means for transmitting the determined frame transmission interval to the network access point, and the network access point comprising storage means for storing at least one default frame transmission interval value for the channel, receiving means for receiving a frame transmission interval value for the channel, and selection means for selectively applying either the received frame transmission interval value or the at least one default frame transmission interval value.

45. The mobile communication system according to claim 44 wherein the determining means is configured to select said frame transmission interval value from a plurality of frame transmission interval values.

46. A mobile communication system according to claim 44 wherein the channel is an enhanced DCH transport channel.
